(19) United States
(12) Patent Application Publication
(10) Pub. No.: US 2022/0057762 A1
(43) Pub. Date: Feb. 24, 2022

(54) BARN CONTROL SYSTEM

(71) Applicant: PROVIDENCE DATA TECHNOLOGIES, LLC, Ames, IA (US)

(72) Inventors: Bradly Joel Brugman, Ames, IA (US); Thomas Hornbeck, San Francisco, CA (US); Brian W. Carr, Ames, IA (US)

(21) Appl. No.: 17/407,341

(22) Filed: Aug. 20, 2021

Related U.S. Application Data
(60) Provisional application No. 63/067,960, filed on Aug. 20, 2020.

(51) Int. Cl. G05B 15/02; A01K 1/00; E05B 47/00; A01K 5/02

(52) U.S. Cl. CPC G05B 15/02; A01K 1/0005; E05B 2047/0048; A01K 5/02; E05B 47/00

(57) ABSTRACT

A barn control system includes a building having at least one door with a lock. Disposed within the building are a plurality of pens with each pen having one or more feed bins, a feed line, a feed motor and a feed pan. A plurality of sensors and activation devices are disposed within the building and are connected to a computer. Based upon sensed information, the computer transmits information to open and close the door, monitor and control feed consumption and ordering, and provide a bio security system.

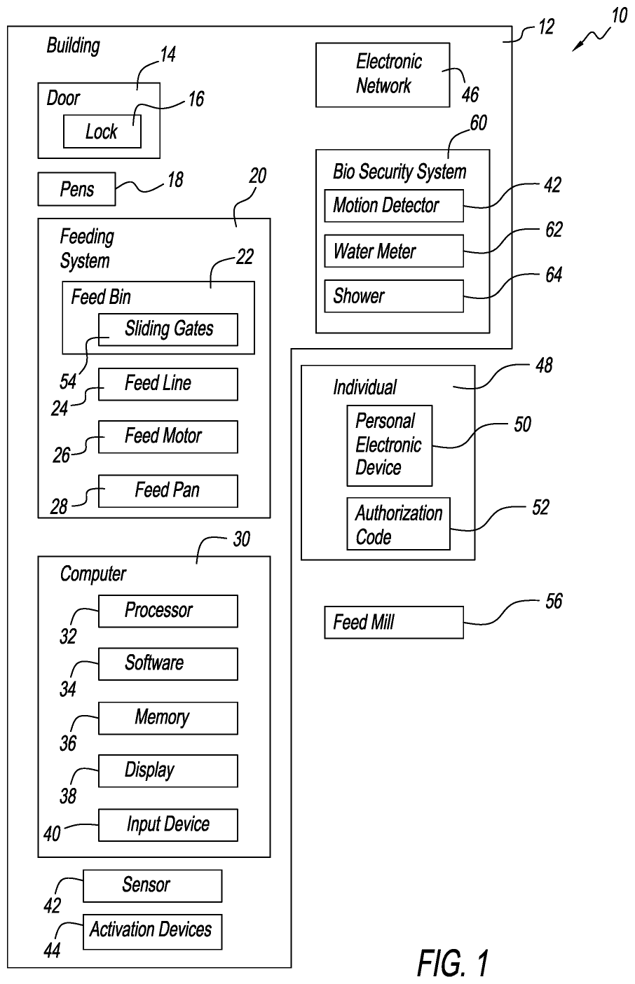

### CROSS REFERENCE TO RELATED APPLICATION

This application claims the benefit of U.S. Provisional Application Ser. No. 63/067,960 filed Aug. 20, 2020, the contents of this application is hereby incorporated by reference in their entirety.

### BACKGROUND OF THE INVENTION

The present invention is directed to a barn or building control system and more particularly for a building control system for monitoring and controlling access to the building and the feeding system for animals.

Feeding systems for animals confined in a building are known in the art. Not only is it important to maintain secure access to the building to prevent against disease, but also to monitor feed consumption, feed availability, and growth rates in order to maximize the growth weight of the individuals. Current systems, while useful, do not provide a complete system for accomplishing weight maximization. They either do not monitor the availability of feed, individually adjust the amount of feed, and order specific feed to be produced from a feed mill to accomplish the goals of the operation. To the extent an operation performs these functions, the process is labor intensive and time consuming. Therefore, there is a need in the art for a system that addresses these deficiencies.

An objective of the present invention is to provide a barn control system that includes secured access into and out of building and a biosecurity system.

Another objective of the present invention is to provide a barn control system that monitors and controls feed consumption, ordering and determines a building consumption rate.

These and other objectives will be apparent to one having ordinary skill in the art based upon the following written description, drawings and claims.

### SUMMARY OF THE INVENTION

A barn control system includes a building having at least one door with a lock. A plurality of pens are disposed within the building with each of the plurality of pens having one or more feed bins, a feed line, a feed motor, and a feed pan. Also disposed within the building are a plurality of sensors and activation devices that are connected to a computer. Based upon sensed information the computer transmits information to the door to open and close the lock. Preferably one or more sensors are positioned adjacent the door. The sensors include a motion sensor and/or a facial recognition sensor. Based upon the sensed information the computer determines whether an individual is authorized to enter the building. After the individual enters the building and based upon sensed information the computer determines if required tasks have been completed before transmitting a signal to open the lock allowing the individual to exit the building. In this way, the system also provides a biosecurity system. For example, for the biosecurity system the computer calculates a dwell time of the individual within the building and determines if an individual has taken a shower before activating the lock to permit the individual to exit the building.

The system also monitors and controls feed consumption and feed ordering. To do so, a plurality of sensors are positioned within the feed bins. Based on sensed information the computer determines whether feed is present in a first bin. If no feed is present in the first bin, then the computer determines if feed is present in a second bin. If no feed is present in either the first or the second bin then the computer sends a signal to activate sliding gates associated with the bins to allow feed to flow into the bins.

The flow of feed to the feed bins can also be adjusted by the computer. Using artificial intelligence and computer vision technology the computer determines the coverage of feed in each bin. When the coverage is too high, the computer sends a signal to reduce feed coverage and when the coverage is too low the computer sends a signal to increase coverage.

The computer also determines the feed consumption of the building. Capacitor sensors are provided for the feed bins and other sensors are associated with the feed motor and feed line. Based upon information provided by the sensors in the feed bin, and associated with the feed line and feed motor, the computer determines the feed consumption of the building. The determined feed consumption of the building is used to calculate an estimated growth rate and weight of an animal, and is also used to send instructions to a feed mill to produce and deliver feed to a specific feed bin.

### BRIEF DESCRIPTION OF THE DRAWING

The FIGURE is a schematic view of the environment of a barn control system.

### DETAILED DESCRIPTION

Referring to the FIGURES, a barn control system 10 includes a barn or building 12 having at least one door 14 with a lock 16. The building 12 is of any type and purpose and as an example only will be described as a hog confinement building. Disposed within the building 12 are a plurality of pens 18. Each pen 18 has a feeding system 20 that includes one or more feed bins 22, a feed line 24, a feed motor 26, and a feed pan 28.

The barn control system 10 also includes a computer 30 having a processor 32, software 34, memory 36, display 38, and input device 40. Disposed throughout the building 12 are a plurality of sensors 42 and activation devices 44. The computer 30 is connected to the sensors 42 and activation devices 44 via an electronic network 46 such as a cellular network enabled PLC gateway or the like so that data is transmitted to control and report on building activity and operation.

One or more sensors 42 are positioned adjacent the one or more doors 14. The door sensors are of any type such as a motion sensor or facial recognition sensor. The sensor(s) transmits information to the computer about an individual 48, where the processor 32, using the software 34, determines whether the individual 48 is authorized to enter the building 12. If authorized, the computer 30 transmits a signal to an activation device 44 that opens the lock 16. Once the individual 48 enters the building 12, the computer 30 sends a signal to the activating device 44 to close the lock 16. The same process is followed for the individual 48 to leave the building 12, although, the computer 30 may send a signal to a personal electronic device 50 of the individual 48 such as a phone, or the like, indicating that required tasks have not been completed. If all required tasks have been completed and the individual is authorized, a signal is sent to the activation device 44 to open the lock 16 allowing the individual 48 to exit the building 12. The individual 48 can manually unlock the door 14 using an authorization code 52.

The building control system 10 also monitors and controls feed consumption and feed ordering. In one aspect, sensors 42 are positioned within the feed bins 22 and transmits information to the computer 30 which determines with the processor, using software 34, whether feed is present in a first bin 22. If no feed is present in the first bin 22, the same process is performed to determine if there is feed in a second bin 22. When the first bin 22 has no feed and the second bin 22 does have feed, the computer 30 sends a signal to an activating device associated with the sliding gates 54 associated with the bins 22, where the gate 54 for the first bin 22, and the gate 54 for the second bin 22, is opened to allow feed to flow to the pens 18.

The flow of feed to the pens 18 is also adjusted by the control system 10. Artificial intelligence (AI) and computer vision technology 42 are used to determine the coverage of feed in each individual feeder in the pens 18. The AI and computer vision technology transmit information to the computer 30 where the processor 32, using the software 34, determines if the feed coverage in the feed pan 28 is too high or too low. If the coverage is too high the computer 30 sends a signal to an activating device 44 that tightens the feeders to allow less feed flow, and if the coverage in the pan 28 is too low the computer sends a signal to the activating device to loosen the feeders to allow more feed to flow. This process is important as too much feed in the pan 28 leads to waste, and too little limits the growth rate of the animal.

The control system 10 also determines the feed consumption of the barn 12. In addition to the capacitor sensors 42 for the feed bins 22, sensors 42 are associated with the feed motor 26 and the feed line 24. Based upon information provided from the feed bin 22, feed line 24, and feed motor 26 sensors 42, the computer 30, using the processor 32 and software 34 determines the feed consumption of the barn 12 and the feed consumption of the barn 12 is used to calculate an estimated growth rate of the animals, and an estimated weight of the animal.

The calculated feed consumption of the barn 12 is also used to send instructions to the feed mill 56 to produce and deliver feed to a specific feed bin 22 if determined by the computer 30 using the processor 32 and software 34, that the amount of feed in the feed bin 22 is determined to be low or out. The computer can also send a notice to the individual 48 if the feed in the bin 22 appears to be bridged.

The control system 10 also includes a biosecurity system 60. The biosecurity system 60 includes a motion detector 42 in the building 12 along with a switch activated by the entry door which causes the computer 30 to calculate the dwell time of the individual 48 within the building 12. A sensor 42 is also associated with a water meter 62 and a moisture detector 42 is associated with a shower 64. The dwell time alone, or in combination with the sensors 42 for the water meter 62 and the shower 64 to determine if the individual 48 has taken a shower. If not, the individual 48 will be notified that all tasks have not been completed when the individual 48 attempts to exit the building 12.

What is claimed is:

1. A barn control system, comprising:
a building having at least one door with a lock;
a plurality of pens disposed within the building with each of the plurality of pens having one or more feed bins, a feed line, a feed motor, and a feed pan;
a plurality of sensors and activation devices disposed within the building and connected to a computer;
wherein the computer based upon sensed information the computer transmits information to the at least one door to open and close the lock.

2. The system of claim 1 wherein the plurality of sensors are positioned adjacent the at least one door.

3. The system of claim 1 wherein the plurality of sensors include a motion sensor.

4. The system of claim 1 wherein the plurality of sensors include a facial recognition sensor.

5. The system of claim 1 wherein based upon sensed information the computer determines whether an individual is authorized to enter the building.

6. The system of claim 1 wherein after an individual enters the building and based upon sensed information the computer determines if required tasks have been completed before transmitting a signal to open the lock allowing the individual to exit the building.

7. A barn control system, comprising:
a building having at least one door with a lock;
a plurality of pens disposed within the building with each of the plurality of pens having one or more feed bins, a feed line, a feed motor, and a feed pan;
a plurality of sensors and activation devices disposed within the building and connected to a computer;
wherein the computer based upon sensed information monitors and controls feed consumption and feed ordering.

8. The system of claim 7 wherein based upon sensed information the computer determines whether feed is present in a first bin of the one or more feed bins.

9. The system of claim 7 wherein the plurality of sensors are positioned within the one or more feed bins.

10. The system of claim 8 wherein based upon sensed information the computer determines whether feed is present in a second bin of the one or more feed bins if feed is not present in the first bin.

11. The system of claim 10 wherein based upon sensed information the computer sends a signal to activate sliding gates associated with the more than one bin to an open position to allow feed to flow into the more than one bin.

12. The system of claim 7 wherein flow of feed to the one or more feed bins is adjusted by the computer.

13. The system of claim 12 wherein the computer uses artificial intelligence and computer vision technology to determine the coverage of feed in each of the one or more feed bins.

14. The system of claim 13 wherein the computer sends a signal to reduce feed coverage if the coverage is too high and sends a signal to increase the feed coverage if the coverage is too low.

15. The system of claim 8 wherein the computer determines the feed consumption of the building.

16. The system of claim 8 wherein the plurality of sensors include capacitor sensors for the more than one feed bins and sensors associated with the feed motor and the feed line.

17. The system of claim 16 wherein based upon information provided from the feed bin, the feed line, and the feed motor, the computer determines the feed consumption of the building.

18. The system of claim 15 wherein the determined feed consumption of the building is used to calculate an estimated growth rate and weight of an animal.

19. The system of claim 15 wherein the determined feed consumption of the building is used to send instructions to a feed mill to produce and deliver feed to a specific feed bin.

20. They system of claim 1 further comprising a biosecurity system.

21. The system of claim 20 wherein the biosecurity system using the computer calculates a dwell time of an individual within the building and determines if an individual has taken a shower before activating the lock to permit the individual to exit the building.
